(19) United States
(12) Patent Application Publication
(10) Pub. No.: US 2006/0054386 A1
(43) Pub. Date: Mar. 16, 2006

(54) Connector for a safety cable

(75) Inventors: Matthew J. Blackford, Hastings, MN (US); J. Thomas Wolner, Red Wing, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/204,200

(22) Filed: Aug. 15, 2005

Related U.S. Application Data
(60) Provisional application No. 60/608,748, filed on Sep. 9, 2004.

(51) Int. Cl. A62B 37/00

(52) U.S. Cl. 182/3

(57) ABSTRACT

A connector for use with a cable includes a cable guide having a channel through which the cable extends and a housing having a cavity configured and arranged to receive the cable guide. A plurality of interconnecting members pivotally interconnect the cable guide and the housing. In a first position, the cable guide moves toward a back of the housing and the plurality of interconnecting members allow the cable to be released. In a second position, the cable guide moves toward a front of the housing and the plurality of interconnecting members engage the cable. The connector is anchored to an anchorage point so that a longitudinal axis of the housing extends generally parallel to the cable when the housing is anchored to the anchorage point thereby minimizing damage to the cable during use.

This application claims the benefit of U.S. Provisional Application No. 60/608,748, filed Sep. 9, 2004.

### FIELD OF THE INVENTION

The present invention relates to fall protection methods and apparatus and, more particularly, to a connector for anchoring an end portion of a safety cable.

### BACKGROUND OF THE INVENTION

Fall protection systems are widely used to reduce the risk of falling and injury associated with people moving and/or working at relatively high elevations above the ground or other surfaces. A common fall protection system utilizes a safety cable with at least one connector for anchoring an end portion of the safety cable, and the safety cable may be used in a horizontal orientation or a vertical orientation relative to the ground or other surface. An example of a fall protection system utilizing a safety cable in a horizontal orientation is disclosed in U.S. Pat. No. 5,343,975 to Riches et al. In order for these systems to work effectively, reliable connections must be maintained between the person and the safety cable and between the safety cable and a stable support structure.

### SUMMARY OF THE INVENTION

A preferred embodiment connector for use with a cable includes a cable guide, a housing, and a plurality of interconnecting members. The cable guide has a channel through which the cable extends, and the housing has a cavity and an anchoring aperture. The cavity is configured and arranged to receive the cable guide. The plurality of interconnecting members has engaging portions and pivotally interconnects the cable guide and the housing. The cable guide and the plurality of interconnecting members have a first position and a second position. The cable guide moves toward a back of the housing and the engaging portions allow the cable to be released from the plurality of interconnecting members when in the first position. The cable guide moves toward a front of the housing and the engaging portions allow the cable to be engaged by the plurality of interconnecting members when in the second position. The anchoring aperture is configured and arranged so that a longitudinal axis of the housing extends parallel to the cable when the housing is anchored by the anchoring aperture to an anchorage point thereby minimizing damage to the cable during use.

A preferred embodiment connector for use with a cable includes at least one cam, a cable guide, and a housing. The at least one cam has a top portion, a middle portion, and a bottom portion. The top portion includes a first aperture, the middle portion includes a second aperture, and the bottom portion includes a hook portion extending outward from the bottom portion. The cable guide has a channel and a third aperture. The cable extends along a bottom of the channel, and the hook portion is placed within the channel proximate the cable and the at least one cam is pivotally connected to the cable guide with a first fastener extending through the second aperture and the third aperture. The housing has a cavity, a fourth aperture, and an anchoring aperture. The cavity is configured and arranged to receive the cable guide and the at least one cam is pivotally connected to the housing with a second fastener extending through the first aperture and the fourth aperture. The at least one cam is pivotable thereby moving the cable guide relative to the housing. The at least one cam and the cable guide have a first position releasing the cable and a second position engaging the cable. The anchoring aperture is proximate the bottom of the channel to allow the housing to extend parallel to the cable thereby minimizing damage to the cable during use.

A preferred embodiment method of anchoring a cable to an anchorage point with a connector includes securing the connector to the anchorage point. The connector has a cable guide, a housing, and a plurality of cams pivotally interconnecting the cable guide and the housing, the plurality of cams pivoting thereby moving the cable guide relative to the housing. The plurality of cams and the cable guide have a first position and a second position. The first position allows the cable to be released from the connector, and the second position allows the cable to be engaged by the connector. An end portion of the cable is inserted into the cable guide in a first direction, and the inserting of the cable in the first direction urges the plurality of cams and the cable guide in the first position to allow for insertion of the cable. The plurality of cams and the cable guide are allowed to move toward the second position to engage the cable thereby anchoring the end portion of the cable, and the connector engages the cable in line with the cable thereby reducing damage to the cable during use.

### BRIEF DESCRIPTION OF THE DRAWINGS

FIG. 1 is an exploded side perspective view of a connector for a safety cable constructed according to the principles of the present invention in an open position;

FIG. 2 is a front view of the connector shown in FIG. 1;

FIG. 3 is a cross section view of the connector shown in FIG. 1 taken along the lines 3-3 in FIG. 2;

FIG. 4 is a side perspective view of the connector shown in FIG. 1;

FIG. 5 is an exploded side perspective view of the connector shown in FIG. 1 in a closed position;

FIG. 6 is a front view of the connector shown in FIG. 5;

FIG. 7 is a cross section view of the connector shown in FIG. 5 taken along the lines 7-7 in FIG. 6;

FIG. 8 is a side perspective view of the connector shown in FIG. 5; and

FIG. 9 is a side partial cross section of the connector shown in FIG. 5.

### DETAILED DESCRIPTION OF A PREFERRED EMBODIMENT

A preferred embodiment connector for use with a safety cable constructed according to the principles of the present invention is designated by the numeral 100 in the drawings.

The connector 100 includes a cable guide 101, a housing 110, a plurality of cams 124 and 125, and a biasing member 128. The cable guide 101 is a U-shaped member having a first side 101a, a second side 101b, and a bottom portion 101c interconnecting the first side 101a and the second side 101b. The first side 101a, the second side 101b, and the bottom portion 101c define a channel 102 through which a cable 109 extends proximate the bottom portion 101c and into which a plurality of cams are placed proximate the cable 109. The first side 101a includes apertures 103a, 104a, 105a, and 106a proximate the top end opposite the bottom portion 101c that are preferably evenly spaced along the length of the first side 101a. Similarly, the second side 101b includes apertures 103b, 104b, 105b, and 106b proximate the top end opposite the bottom portion 101c that are preferably evenly spaced along the length of the second side 101b. Respective apertures 103a and 103b, 104a and 104b, 105a and 105b, and 106a and 106b are opposing and are in alignment with one another so that rivets 107 may be inserted through the opposing apertures.

Optionally, the cable guide 101 may include a flange (not shown) operatively connected to the bottom portion 101c and extending downward from an end of the bottom portion 101c to provide a surface upon which force may be exerted with a hammer or the like to assist in releasing the cable guide 101 from the cable 109, which may be useful after a load has been applied to the cable 109. Preferably, the flange is a block of metal welded onto the end of the cable guide 101 proximate aperture 106a approximately 90 degrees from the longitudinal axis of the cable guide 101 and extending downward beyond the housing 110 to allow easy access to the flange when the connector 100 is assembled.

The housing 110 is preferably an upside down U-shaped member having a first side 110a, a second side 110b, and a top portion 110c interconnecting the first side 110a and the second side 110b. Although the housing 110 is shown as a U-shaped member, it is recognized that two L-shaped members may be operatively connected to form the U-shaped member. The first side 110a, the second side 110b, and the top portion 110c define a cavity 111 having a width wide enough to accommodate the cable guide 101. The first side 110a includes a slot 116a and the second side 110b includes a slot 116b. The slots 116a and 116b are opposing proximate the middle of the first and second sides 110a and 110b and are in alignment with one another. The first side 110a includes apertures 112a, 113a, 114a, and 115a proximate the top of the slot 116a that are preferably evenly spaced along the length of the slot 116a. Similarly, the second side 110b includes apertures 112b, 113b, 114b, and 115b proximate the top of the slot 116b that are preferably evenly spaced along the length of the slot 116b. Respective apertures 112a and 112b, 113a and 113b, 114a and 114b, and 115a and 115b are opposing and are in alignment with one another so that rivets 121 may be inserted through the opposing apertures. If two L-shaped members are used for the housing 110, tubular spacers (not shown) may be used to keep the two halves of the housing, sides 110a and 110b, a predetermined distance apart. The tubular spacers have bores corresponding with the apertures 112a and 112b, 113a and 113b, 114a and 114b, and 115a and 115b, and the rivets 121 also extend through the bores. Preferably, the first side 110a also includes a pin member 122 above the aperture 115a extending outward into the cavity 111.

The back of the housing 110 includes an elbow portion 117 extending outward and tapering slightly downward from proximate the top portion 110c. Proximate the bottom end of the elbow portion 117 are apertures 118a and 118b in the first and second sides 110a and 110b, respectively, that are opposing and are in alignment with one another. The front and top ends of the first and second sides 110a and 110b include apertures 119a and 119b, respectively, that are opposing and are in alignment with one another. A tubular spacer 120 is preferably secured within the cavity 111 between the apertures 119a and 119b with a fastener (not shown). The spacer 120 keeps the sides 110a and 110b a predetermined distance apart.

The plurality of cams preferably includes a front cam 124 and three cams 125, each including a top and a bottom, the bottom having a hook portion 124d and 125c, respectively. When placed in a vertical orientation relative to the cable guide 101 and the housing 110, the hook portions 124d and 125c extend in a direction toward the back of the connector 100. The front cam 124 has an extended top including an aperture 124a proximate the extended top, an aperture 124b proximate the middle, and an aperture 124c proximate the hook portion 124d. The cams 125 include an aperture 125a proximate the middle and an aperture 125b proximate the hook portion 125c.

The biasing member 128 is preferably a helical coiled spring including a first end 128a and a second end 128b. The biasing member 128 interconnects the housing 110 and the front cam 124.

To assemble the connector 100, the cams 124 and 125 are operatively connected to the cable guide 101. The hook portions 124d and 125c of the cams 124 and 125, respectively, are placed within the channel 102 of the cable guide 101 so that the hook portions 124d and 125c extend in a direction toward the back of the connector 100. A rivet 107 is placed through aperture 103a of the first side 101a, through aperture 124c of the cam 124, and through the aperture 103b of the second side 101b to secure cam 124 to the cable guide 101. A rivet 107 is placed through aperture 104a of the first side 101a, through aperture 125b of the first cam 125, and through the aperture 104b of the second side 101b to secure the first cam 125 to the cable guide 101. Similarly, a rivet 107 is placed through aperture 105a of the first side 101a, through aperture 125b of the second cam 125, and through the aperture 105b of the second side 101b to secure the second cam 125 to the cable guide 101. Also similarly, a rivet 107 is placed through aperture 106a of the first side 101a, through aperture 125b of the third cam 125, and through the aperture 106b of the second side 101b to secure the third cam 125 to the cable guide 101.

The cable guide 101 is then placed within the cavity 111 of the housing 110 with the bottom portion 110c of the cable guide 101 proximate the bottom of the connector 100 and the top portion 110c of the housing 110 proximate the top of the connector 100. The cams 124 and 125 are then operatively connected to the housing 110. A rivet 121 is placed through aperture 112a of the first side 110a, through the aperture 124b of the cam 124, and through the aperture 112b of the second side 110b to secure the cam 124 to the housing 110. A rivet 121 is placed through aperture 113a of the first side 110a, through the aperture 125a of the first cam 125, and through aperture 113b of the second side 110b to secure the first cam 125 to the housing 110. Similarly, a rivet 121 is placed through aperture 114a of the first side 110a, through the aperture 125a of the second cam 125, and through aperture 114b of the second side 110b to secure the second cam 125 to the housing 110. Also similarly, a rivet 121 is placed through aperture 115a of the first side 110a, through the aperture 125a of the third cam 125, and through aperture 115b of the second side 110b to secure the third cam 125 to the housing 110. The cams 124 and 125 interconnect the cable guide 101 and the housing 110. Preferably, rivets 107 may be seen through slots 116a and 116b to provide visual indication that the cams 124 and 125 are properly engaging the cable 109 when in use. In addition, the slots 116a and 116b allow the rivets 107 to move through the range of motion without interference from the housing 110. Although four cams are preferred, it is recognized that any suitable number of cams could be used. The plurality of cams is used to distribute the load over more length of the cable 109 thereby reducing the localized load on the cable 109. Also, the plurality of cams makes it easier to release the cable 109 from the connector 100 because the localized load on the cable 109 is reduced.

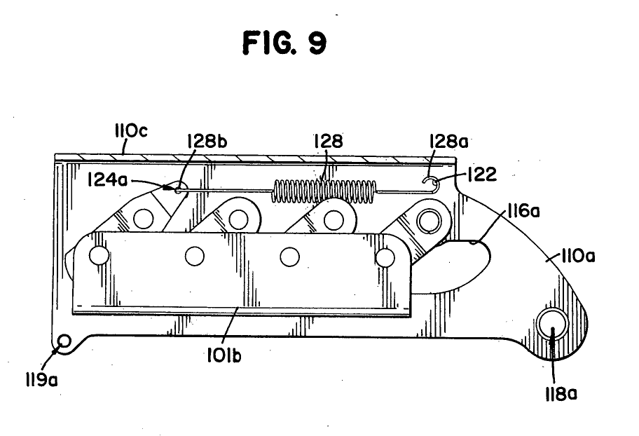

A fastener (not shown) such as a rivet is placed through aperture 119a of the first side 110a, through the bore 120a of the roller 120, and through the aperture 119b of the second side 110b to secure the roller 120 to the housing 110. The biasing member 128 interconnects the cam 124 and the housing 110, as shown in FIG. 9. The first end 128a of the biasing member 128 is preferably operatively connected to the top portion 110c of the housing 110 proximate the back of the housing 110 with the pin member 122 by looping about the pin member 122. The second end 128b of the biasing member 128 is preferably inserted through the aperture 124a of the cam 124. The biasing member 128 continually biases or pulls the top of the cam 124 toward the back of the housing 110. Because the cam 124 is operatively connected to the cable guide 101, to which the cams 125 are also operatively connected, the biasing member 128 in effect also continually biases or pulls the tops of the cams 125 toward the back of the housing 110 by continually biasing or pulling the top of the cam 124. In other words, as the top of the cam 124 is biased or pulled toward the back of the housing 110, the cable guide 101 slides in a forward direction toward the front of the connector 100 and the hook portion 124d points in a downward direction toward the bottom of the connector 100. The cam 124 pivots between the two pivot points proximate the rivet 107 in the cable guide 101 and the rivet 121 in the housing 110. As the cable guide 101 slides forward, the cams 125 also pivot so that the tops of the cams 125 also point toward the back of the housing 110. This is shown in FIG. 7.

The connector 100 is preferably used as an end termination to terminate a length of cable 109 used by workers to provide protection from falls when working at unsafe elevations by connecting an end portion of the cable 109 to an anchorage point with the connector 100. The connector 100 could also be used in many other applications known in the art where the termination of a cable is needed. For example, the connector 100 could also be used for securing, lifting, pulling, guying, and other applications in which cable is used. The cable 109 could be a wire rope, a fiber rope, a rod, or any other suitable type of elongate member well known in the art.

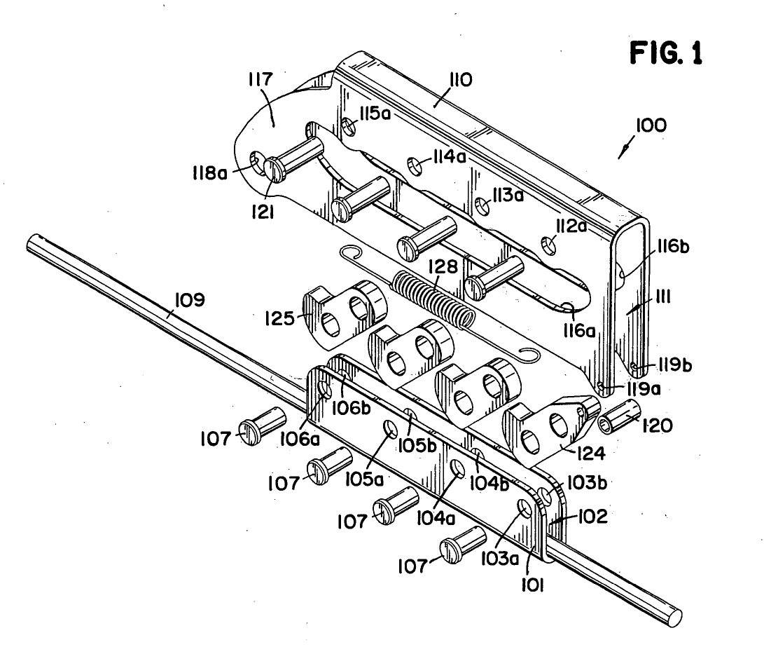

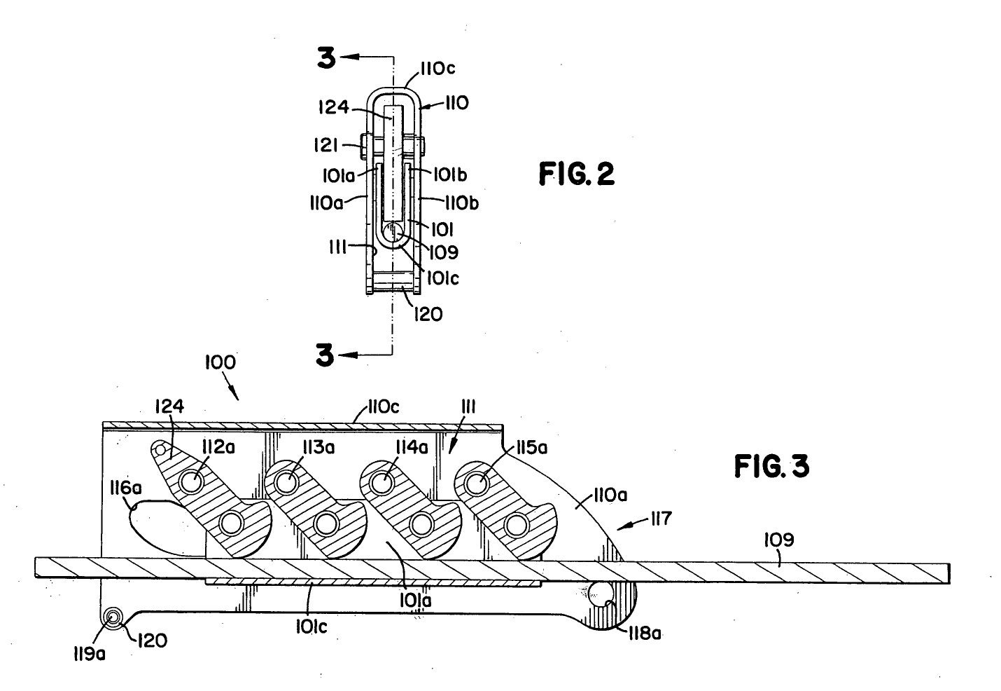

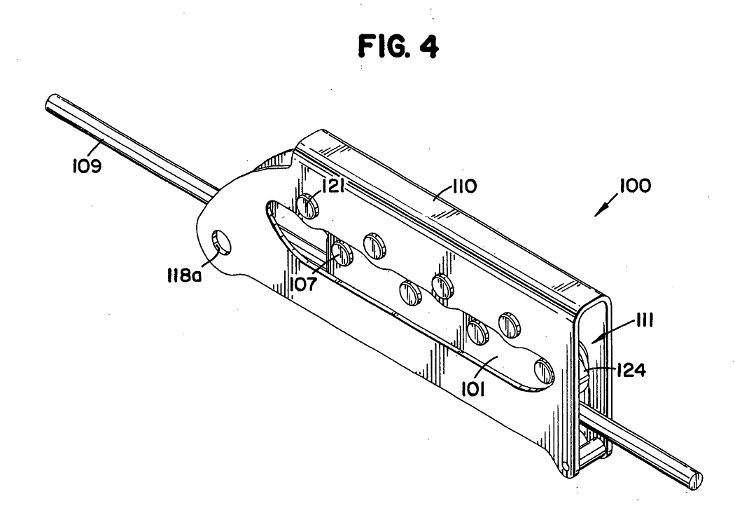

In operation, a pin or a bolt (not shown) is used to connect to the connector 100 to an anchorage point. The pin or the bolt is inserted through the apertures 118a and 118b and connected as in well known in the art to the anchorage point. The end portion of the cable 109 is inserted within the channel 102 of the cable guide 101 between the bottom portion 101c and the hook portions 124d and 125c of the cams 124 and 125 so that the end portion of the cable 109 extends out the back of the housing 110. As the cable 109 is being inserted into the connector 100 through the cable guide 101, the force of the biasing member 128 is overcome and the cable guide 101 slides toward the back of the connector 100 thereby causing the cams 124 and 125 to pivot so that the tops of the cams 124 and 125 point in a direction toward the front of the connector 100 and the hook portions 124d and 125c point in a direction toward the top of the connector 100. In this first position, the hook portions 124d and 125c do not engage the cable 109 thereby allowing the cable 109 to be inserted into the connector 100, as shown in FIGS. 1-4.

After the cable 109 has thus been inserted into the connector 100, the force of the biasing member 128 resumes and an initial load is placed on the cable 109 by the cams 124 and 125 because the biasing member 128 interconnects the cam 124 and the housing 110. The biasing member 128 causes the tops of the cams 124 and 125 to point in a direction toward the back of the connector 100 and the hook portions 124d and 125c of the cams 124 and 125 to point in a direction toward the bottom of the connector 100. Thus, the hook portions 124d and 125c of the cams 124 and 125 place pressure on the cable 109 against the bottom portion 101c of the cable guide 101, as shown in FIG. 7. Preferably, the hook portions 124d and 125c of the cams 124 and 125 place pressure on the cable 109 and may make indentations in the cable 109 but do not pierce the cable 109 so as to minimize damage to the cable 109 from use of the connector 100.

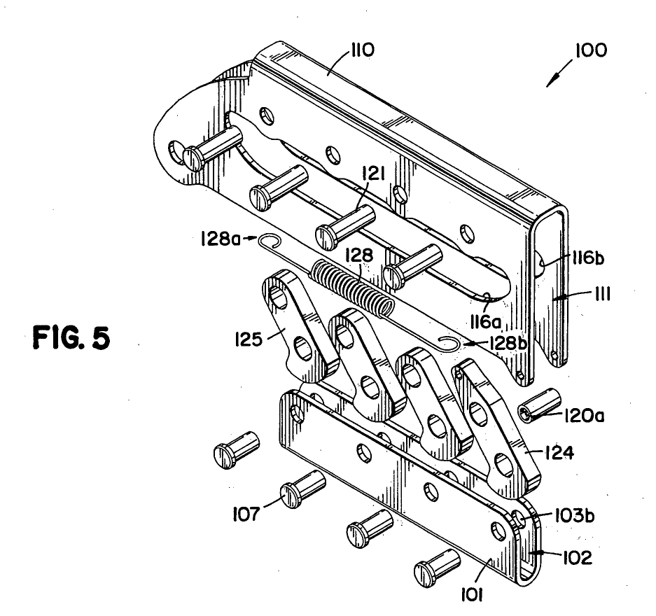

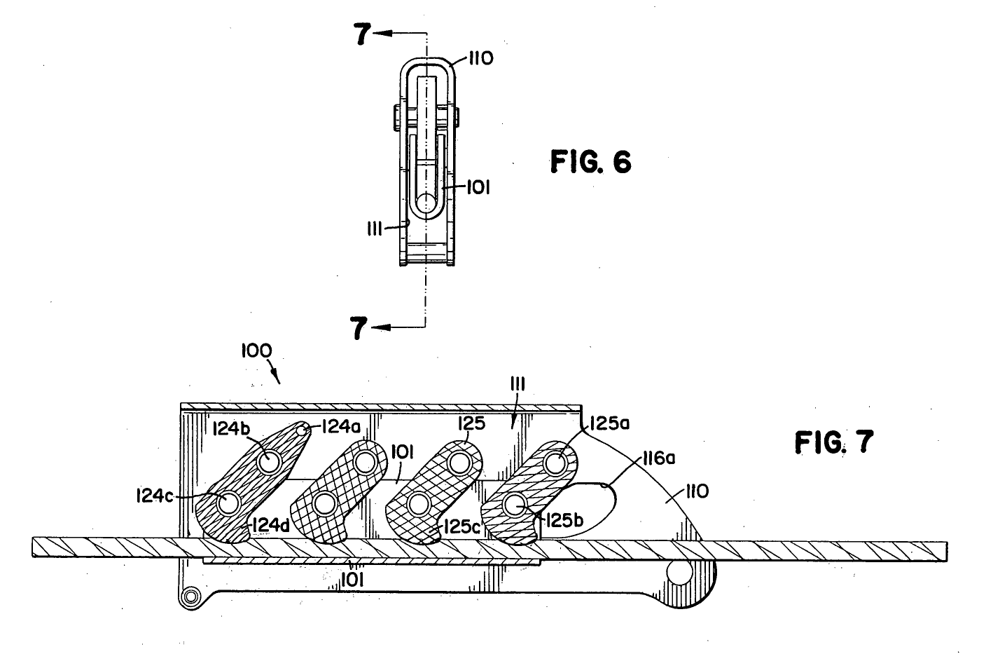

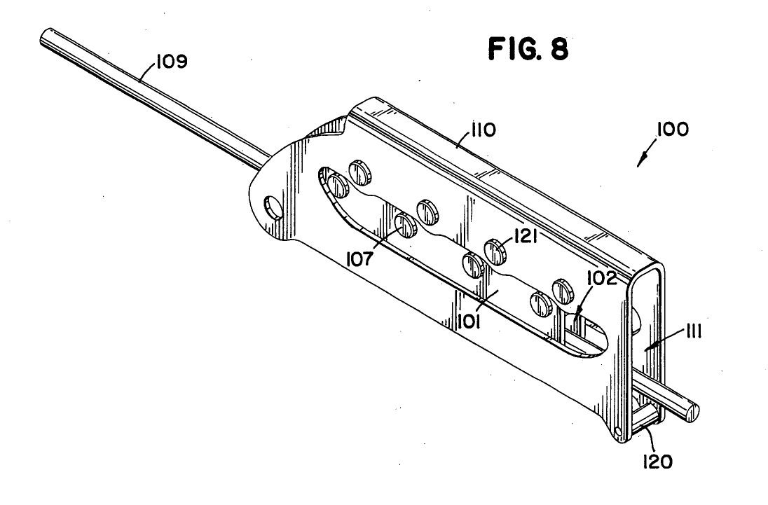

The cable 109 is then tensioned by means well known in the art. As the cable 109 is being tensioned, the cable 109 is pulled outward from the front of the connector 100 proximate the roller 120, and this pulling of the cable 109 causes the cable guide 101 to slide further toward the front of the connector 100 thereby causing the hook portions 124d and 125c of the cams 124 and 125 to place more pressure on the cable 109 against the cable guide 101. This is shown in FIGS. 5-8. The cable 109, positioned between the cams 124 and 125 and the bottom portion 101c of the cable guide 101, is held in place by friction from the cams 124 and 125 exerting pressure upon the cable 109 against the bottom portion 101c of the cable guide 101. As the cable 109 is pulled outward from the front of the connector 100, more pressure is placed on the cable 109 against the cable guide 101 by the hook portions 124d and 125c. In other words, in this second position, the cams 124 and 125 pinch the cable 109 against the bottom portion 101c of the cable guide 101 and this friction secures the cable 109 within the connector.

As tension is applied to the cable 109, the cable guide 101 is pulled in one direction by the cable 109 and the housing 110 is pulled in an opposite direction by the anchorage point, which causes greater engagement of the cams 124 and 125 on the cable 109 against the cable guide 101. The increased tension on the cable 109 causes the grip on the cable 109 by the connector, 100 to increase. The locking force of the connector 100 is preferably the force of the biasing member 128 and the friction between the cams 124 and 125 and the cable 109 against the cable guide 101.

The apertures 118a and 118b of the connector 100 are configured and arranged so that when the connector 100 is operatively connected to the anchorage point, the longitudinal axis of the connector 100 is generally parallel with the cable 109. Preferably, the apertures 118a and 118b are proximate the bottom portion 101c of the cable guide 101 within the housing 110. This ensures that the cable 109 is engaged in a relatively straight line relative to the connector 100, without bending the cable 109. Otherwise, if the connector 100 is not parallel with the line of the cable 109, the load point on the cable 109 will not be in line with the connector 100 and the cable 109 will tend to kink and become damaged proximate the roller 120 thereby reducing the number of times the cable 109 can be used.

To disengage the cable 109 from the connector 100 or to simply adjust the length of the cable 109, the cable guide 101 can be manually retracted (pulled in a direction toward the back of the connector 100) to disengage the hook portions 124d and 125c of the cams 124 and 125 from the cable 109 to allow adjustment of the connector 100 along the length of the cable 109 thereby allowing the length of the cable span to be changed.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A connector for use with a cable, comprising:
a) a cable guide having a channel through which the cable extends;
b) a housing having a cavity and an anchoring aperture, the cavity being configured and arranged to receive the cable guide; and
c) a plurality of interconnecting members having engaging portions, the plurality of interconnecting members pivotally interconnecting the cable guide and the housing, the cable guide and the plurality of interconnecting members having a first position and a second position, the cable guide moving toward a back of the housing and the engaging portions allowing the cable to be released from the plurality of interconnecting members when in the first position, the cable guide moving toward a front of the housing and the engaging portions allowing the cable to be engaged by the plurality of interconnecting members when in the second position, the anchoring aperture being configured and arranged so that a longitudinal axis of the housing extends parallel to the cable when the housing is anchored by the anchoring aperture to an anchorage point thereby minimizing damage to the cable during use.

2. The connector of claim 1, further comprising:
a) first apertures and second apertures in the plurality of interconnecting members, the first apertures being proximate middle portions of the plurality of interconnecting members, the second apertures being proximate top portions of the plurality of interconnecting members;
b) first fasteners extending through the first apertures and operatively connecting the plurality of interconnecting members to the cable guide; and
c) second fasteners extending through the second apertures and operatively connecting the plurality of interconnecting members to the housing, the plurality of interconnecting members being pivotable between the cable guide and the housing.

3. The connector of claim 1, wherein the engaging portions are hook portions moving away from the channel of the cable guide in the first position to allow the cable to be released from the plurality of interconnecting members and moving toward the channel of the cable guide in the second position to allow the cable to be engaged by the plurality of interconnecting members.

4. The connector of claim 3, further comprising a biasing member interconnecting at least one of the plurality of interconnecting members and the housing, the biasing member urging the hook portion of the at least one of the plurality of interconnecting members toward the channel of the cable guide in the second position to allow the cable to be engaged by the plurality of interconnecting members.

5. The connector of claim 3, wherein the engaging portions are hook portions pointing in an upward direction when in the first position to allow the cable to be released from the plurality of interconnecting members and pointing in a downward direction when in the second position to allow the cable to be engaged by the plurality of interconnecting members.

6. The connector of claim 5, further comprising a biasing member interconnecting at least one of the plurality of interconnecting members and the housing, the biasing member urging the hook portion of the at least one of the plurality of interconnecting members in the downward direction thereby urging the plurality of interconnecting members and the cable guide in the second position.

7. The connector of claim 1, wherein the cable guide and the plurality of interconnecting members engage the cable parallel to the longitudinal axis of the housing.

8. The connector of claim 1, wherein the plurality of interconnecting members are evenly spaced along the longitudinal axis of the housing.

9. A connector for use with a cable, comprising:
a) at least one cam having a top portion, a middle portion, and a bottom portion, the top portion including a first aperture, the middle portion including a second aperture, and the bottom portion including a hook portion extending outward from the bottom portion;
b) a cable guide having a channel and a third aperture, the cable extending along a bottom of the channel, the hook portion being placed within the channel proximate the cable and the at least one cam being pivotally connected to the cable guide with a first fastener extending through the second aperture and the third aperture; and
c) a housing having a cavity, a fourth aperture, and an anchoring aperture, the cavity being configured and arranged to receive the cable guide, the at least one cam being pivotally connected to the housing with a second fastener extending through the first aperture and the fourth aperture, the at least one cam pivoting thereby moving the cable guide relative to the housing, the at least one cam and the cable guide having a first position releasing the cable and a second position engaging the cable, the anchoring aperture being proximate the bottom of the channel allowing the housing to extend parallel to the cable thereby minimizing damage to the cable during use.

10. The connector of claim 9, wherein the at least one cam is four cams.

11. The connector of claim 10, wherein the four cams are evenly spaced along a longitudinal axis of the housing.

12. The connector of claim 9, further comprising a biasing member interconnecting the at least one cam and the housing, the biasing member urging the hook portion of the at least one cam in a downward direction thereby urging the at least one cam and the cable guide in the second position.

13. A method of anchoring a cable to an anchorage point with a connector, the connector having a cable guide, a housing, and a plurality of cams pivotally interconnecting the cable guide and the housing, the plurality of cams pivoting thereby moving the cable guide relative to the housing, the plurality of cams and the cable guide having a first position and a second position, the first position allowing the cable to be released from the connector, the second position allowing the cable to be engaged by the connector, comprising:
a) securing the connector to the anchorage point;
b) inserting an end portion of the cable into the cable guide in a first direction, the inserting of the cable in the first direction urging the plurality of cams and the cable guide in the first position to allow for insertion of the cable; and
c) allowing the plurality of cams and the cable guide to move toward the second position to engage the cable thereby anchoring the end portion of the cable, the connector engaging the cable in line with the cable thereby reducing damage to the cable during use.

14. The method of claim 13, further comprising pulling the cable in a second direction urging the plurality of cams and the cable guide into the second position to further engage the cable.

15. The method of claim 13, further comprising urging the plurality of cams and the cable guide in the first position and releasing the cable from the connector.

16. The method of claim 13, further comprising biasing the plurality of cams and the cable guide in the second position.
